(19) United States
(12) Patent Application Publication
(10) Pub. No.: US 2019/0011011 A1
(43) Pub. Date: Jan. 10, 2019

(54) VIBRATION ABSORBER FOR INTERNAL COMBUSTION ENGINE

(71) Applicant: HONDA MOTOR CO., LTD., Tokyo (JP)

(72) Inventors: Masanari HIGUCHI, Wako-shi (JP); Masaya MIYAZAWA, Wako-shi (JP)

(21) Appl. No.: 16/017,011

(22) Filed: Jun. 25, 2018

(30) Foreign Application Priority Data
Jul. 5, 2017 (JP) 2017-131958

(51) Int. Cl. F16F 15/14; F16F 15/315; F16F 15/28; F16F 15/31

(52) U.S. Cl. CPC F16F 15/145; F16F 15/31; F16F 15/283; F16F 15/3153

(57) ABSTRACT

Provided is a vibration absorber for an internal combustion engine having a plurality of cylinders arranged in a row. The vibration absorber is provided with at least one centrifugal pendulum damper (51) provided in at least one of positions of the crankshaft of the engine corresponding to anti-nodes of one-node mode, two-node mode and three-node mode torsional vibrations of the crankshaft.

### TECHNICAL FIELD

The present invention relates to a vibration absorber for an internal combustion engine.

### BACKGROUND ART

The centrifugal pendulum damper for reducing torsional vibrations of a crankshaft of an internal combustion engine is known. The damper may be attached to a crank arm of the crankshaft. See JP2001-153185A, for instance.

JP2001-153185A does not specifically disclose where a centrifugal pendulum damper should be attached for an optimum performance. The amplitude of a resonant torsional vibration of a crankshaft varies depending on the lengthwise position thereof. Therefore, it can be surmised that the positioning of a centrifugal pendulum damper is important in optimizing the performance of the centrifugal pendulum damper.

### SUMMARY OF THE INVENTION

Based on such a recognition by the inventors of this application and in view of the problems of the prior art, a primary object of the present invention is to provide a vibration absorber for an internal combustion engine that can effectively reduce the torsional vibration of the crankshaft of the engine.

To achieve such an object, the present invention provides a vibration absorber for an internal combustion engine having a plurality of cylinders arranged in a row, comprising: a crankshaft (10) corresponding to the cylinders; a crank pulley (33) provided in a first end portion (25) of the crankshaft; a flywheel (40) provided in a second end portion (26) of the crankshaft; and at least one centrifugal pendulum damper (51) provided in at least one of positions of the crankshaft corresponding to anti-nodes of one-node mode, two-node mode and three-node mode torsional vibrations of the crankshaft.

Thereby, the resonant vibrations of the crankshaft can be favorably suppressed, and the torsional vibrations of the crankshaft can be minimized. In the normal rotational speed range, one-node mode, two-node mode and three-node mode torsional vibrations occur. Therefore, by providing the centrifugal pendulum damper in any of the anti-nodes of such vibration modes, the natural frequency vibrations of the crankshaft can be effectively reduced, and the resonant torsional vibrations of the crankshaft can be reduced.

Preferably, the at least one centrifugal pendulum damper includes a centrifugal pendulum damper positioned so as to correspond to a cylinder (12B, 12C) adjacent to a position located ⅓ to ½ of a length of the crankshaft as measured from the second end portion of the crankshaft.

Thereby, the centrifugal pendulum damper can be positioned in the anti-nodes of all of the one-node mode, two-node mode and three-node mode torsional vibrations, not only the one-node mode vibration but also the two-node mode and three-node mode vibrations can be reduced.

The at least one centrifugal pendulum damper may include a centrifugal pendulum damper located in the first end portion of the crankshaft.

Thereby, the centrifugal pendulum damper can be positioned in the anti-node of the one-node mode vibration.

Preferably, the at least one centrifugal pendulum damper is tuned to a higher order torsional vibration of the crankshaft than a second-order torsional vibration.

Thereby, the vibrations of the engine in the normal rotational speed range can be reduced. Since the higher order torsional vibration of the crankshaft coincides with the natural frequency of the crankshaft in the normal rotational speed range of the engine, resonant vibration can be effectively minimized.

Preferably, the at least one centrifugal pendulum damper is tuned to at least one of fourth-order, sixth-order and eighth-order torsional vibrations of the crankshaft.

By reducing at least one of the fourth-order, sixth-order and eighth-order torsional vibrations of the crankshaft, the vibrations of the engine in the normal rotational speed range can be reduced.

The at least one centrifugal pendulum damper may include two or more centrifugal pendulum dampers located at a same lengthwise position of the crankshaft.

Thereby, the multiple centrifugal pendulum dampers may be positioned in a part corresponding to the anti-nodes of multiple modes of vibrations so that the torsional vibrations can be reduced in an efficient manner.

Preferably, the two or more centrifugal pendulum dampers located at a same lengthwise position of the crankshaft are tuned to torsional vibrations of different orders.

Thereby, the centrifugal pendulum dampers tuned to different modes of vibrations may be positioned in a part corresponding to the anti-nodes of these modes of vibrations so that the torsional vibrations can be reduced in an efficient manner.

According to a particularly preferred embodiment of the present invention, the crank pulley includes a pulley inner part (34) fixedly connected to the crankshaft, and a pulley outer part (35) connected to an outer periphery of the inner part via an elastic member (36) and configured to have a belt passed around an outer periphery thereof, the at least one centrifugal pendulum damper comprising a centrifugal pendulum damper attached to the pulley inner part.

Thereby, the centrifugal pendulum damper can be provided at a desired radial distance from the center axis of the crankshaft.

According to a preferred embodiment of the present invention, the cylinders consist of a first cylinder (12A), a second cylinder (12B), a third cylinder (12C), and a fourth cylinder (12D) arranged in that order from the first end portion of the crankshaft, and the at least one centrifugal pendulum damper comprises a fourth-order damper (51B) attached to the pulley inner part, and a sixth-order damper (51C) attached to a part of the crankshaft corresponding to the second cylinder or the third cylinder.

Thereby, the resonant vibration of the crankshaft in the normal rotational speed range of the engine can be suppressed. In particular, the fourth-order vibration may resonate at the natural frequency of the one-node vibration in the normal rotational speed range of the engine, but the resonant fourth-order vibration can be effectively suppressed by providing the fourth-order damper on the pulley inner part corresponding to the anti-node of the one-node vibration. Similarly, the sixth-order vibration may resonate at the natural frequency of the two-node vibration in the normal rotational speed range of the engine, but the resonant sixth-order vibration can be effectively suppressed by providing the sixth-order damper on the part of the crankshaft corresponding to the second cylinder or the third cylinder corresponding to the anti-node of the two-node vibration.

The at least one centrifugal pendulum damper may further comprise an additional sixth-order damper (51C) attached to the pulley inner part.

Thereby, the resonant vibration of the crankshaft in the normal rotational speed range of the engine can be suppressed. In particular, the sixth-order vibration may resonate at the natural frequency of the one-node vibration in the normal rotational speed range of the engine, but the resonant sixth-order vibration can be effectively suppressed by providing the sixth-order damper on the pulley inner part corresponding to the anti-node of the one-node vibration.

Preferably, the at least one centrifugal pendulum damper further comprises an eighth-order damper (51D) attached to a part of the crankshaft corresponding to the second cylinder or the third cylinder.

Thereby, the resonant vibration of the crankshaft in the normal rotational speed range of the engine can be suppressed. In particular, the eighth-order vibration may resonate at the natural frequency of the two-node vibration in the normal rotational speed range of the engine, but the resonant eighth-order vibration can be effectively suppressed by providing the eighth-order damper on the part of the crankshaft corresponding to the second cylinder or the third cylinder corresponding to the anti-node of the two-node vibration.

In a preferred embodiment of the present invention, the cylinders consist of a first cylinder (12A), a second cylinder (12B), a third cylinder (12C), and a fourth cylinder (12D) arranged in that order from the first end portion of the crankshaft, and the at least one centrifugal pendulum damper comprises a fourth-order damper (51B), a sixth-order damper (51C) and an eighth-order damper (51D) attached to the pulley inner part, and another fourth-order damper, another sixth-order damper and another eighth-order damper attached to a part of the crankshaft corresponding to the second cylinder or the third cylinder.

Thereby, the resonant vibration of the crankshaft in the normal rotational speed range of the engine can be suppressed.

The present invention thus provides a vibration absorber for an internal combustion engine that can effectively reduce the torsional vibration of the crankshaft of the engine.

### BRIEF DESCRIPTION OF THE DRAWING(S)

FIG. 1 is a sectional view of an internal combustion engine according to an embodiment of the present invention;

FIG. 2 is a side view of a centrifugal pendulum damper used in the engine shown in FIG. 1;

FIG. 3 is a dynamic model of a crankshaft according to the present embodiment;

FIG. 4 is a dynamic model of a crankshaft according to First Example for Comparison and graphic representation of different modes of the vibration of the crankshaft of the First Example for Comparison;

FIG. 5a is a graph showing the torsional resonant vibrations of different orders that occur in relation to the rotational speeds of the engine in First Example for Comparison;

FIG. 5b is a graph showing the angular accelerations of the crankshaft in various torsional vibration modes in relation to the rotational speed of the engine in First Example for Comparison;

FIG. 6a is a graph showing the angular accelerations of the crankshaft in various torsional vibration modes in relation to the rotational speed of the engine of Second Example for Comparison;

FIG. 6b is a graph showing the angular accelerations of the crankshaft in various torsional vibration modes in relation to the rotational speed of the engine of the present embodiment;

FIG. 7 is a dynamic model of a crankshaft according to a modified embodiment;

FIG. 8 is a dynamic model of a crankshaft according to another modified embodiment;

FIG. 9 is a dynamic model of a crankshaft according to yet another modified embodiment;

FIG. 10 is a dynamic model of a crankshaft according to yet another modified embodiment; and

FIG. 11 is a dynamic model of a crankshaft according to yet another modified embodiment (three-cylinder engine).

### DESCRIPTION OF THE PREFERRED EMBODIMENT(S)

Preferred embodiments of the present invention are described in the following with reference to the appended drawings.

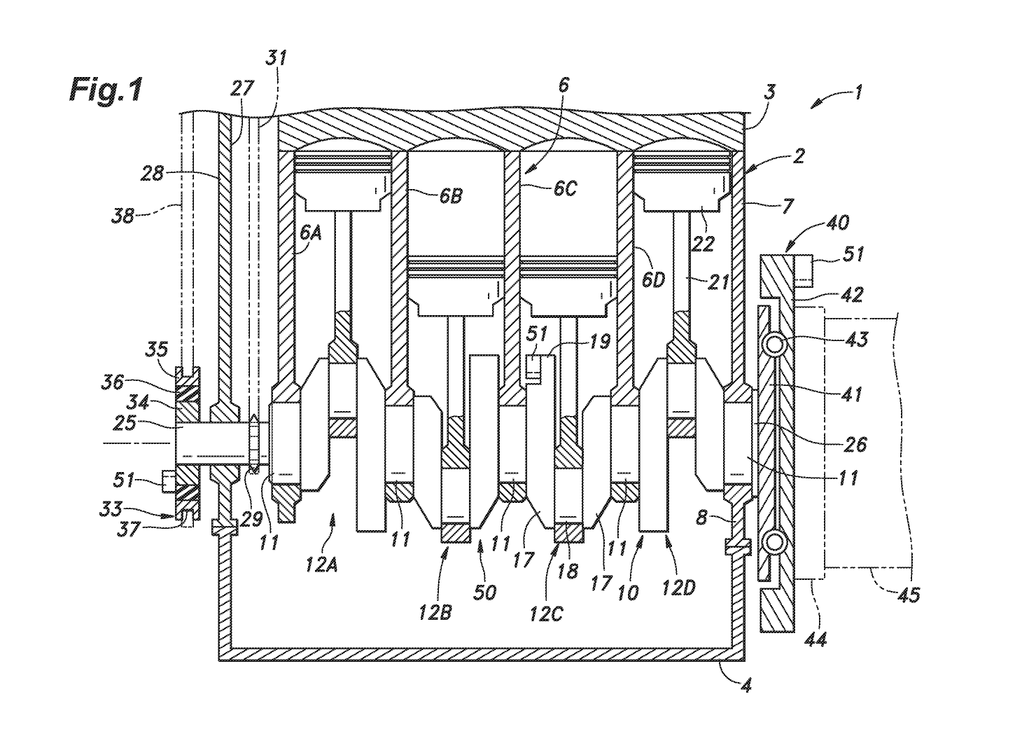

As shown in FIG. 1, an internal combustion engine 1 includes a cylinder block 2, a cylinder head 3 connected to the upper end of the cylinder block 2, and an oil pan 4 connected to the lower end of the cylinder block 2. The cylinder block 2 consists of an upper block 7 defining four cylinders 6 arranged in a single row, and a lower block 8 connected to the lower end of the upper block 7. In this disclosure, the cylinders 6 are named as a first cylinder 6A, a second cylinder 6B, a third cylinder 6C, and a fourth cylinder 6D. The end of the engine 1 corresponding to the first cylinder 6A is named as one end, and the end of the engine corresponding to the fourth cylinder 6D is named as other end.

A crankshaft 10 is rotatably supported between the upper block 7 and the lower block 8. The crankshaft 10 extends in the cylinder row direction and faces the lower ends of the first to fourth cylinders 6A to 6D. The crankshaft 10 is provided with five crank journals 11 arranged coaxially with one another, and first to fourth crank throws 12A to 12D provided between the respective crank journals 11. Each crank journal 11 is rotatably supported between the upper block 7 and the lower block 8 via bearings (not shown in the drawings), and defines a rotation axis of the crankshaft 10.

The first to fourth crank throws 12A to 12D correspond to the first to fourth cylinders 6A to 6D, respectively. Each crank throw 12 is formed by a pair of crank webs 17 and a crank pin 18 provided between the crank webs 17. The crank webs 17 are connected to the adjacent crank journals 11 and extend radially from the crank journal 11. Each crank pin 18 is disposed parallel to and offset from the crank journal 11. Each crank web 17 is provided with a counterweight 19 on the side thereof remote from the crank pin 18.

The crank pins 18 of the first and fourth crank throws 12A and 12D are disposed in a same phase, and the crank pins 18 of the second and third crank throws 12B and 12C are offset by 180° from the crank pins 18 of the first and the fourth crank throws 12A and 12D. Each crank pin 18 is connected to a piston 22 slidably received in the corresponding cylinder 6 via a connecting rod 21.

A first end portion 25 of the crankshaft 10 on the one end of the engine 1 extends from the outer end of the crank journal 11 adjoining the first crank throw 12A, and protrudes outwardly of the cylinder block 2. The second end portion 26 of the crankshaft 10 on the other end of the engine 1 extends from the outer end of the crank journal 11 provided adjacent to the fourth crank throw 12D, and protrudes outward of the cylinder block 2.

A chain case 28 is attached to the one end of the engine 1 so as to define a chain chamber 27 in cooperation with the cylinder block 2 and the cylinder head 3. The lower edge of the chain case 28 is joined to the upper edge of the oil pan 4. The first end portion 25 of the crankshaft 10 is passed through the chain case 28, and projects outwardly of the chain case 28. The part of the first end portion 25 of the crankshaft 10 located in the chain chamber 27 is fitted with a sprocket 29. A timing chain 31 is passed around the sprocket 29 and another sprocket (not shown in the drawings) fitted on a camshaft of a valve actuating mechanism (not shown in the drawings) in a per se known manner.

A part of the first end portion 25 of the crankshaft 10 projecting outwardly from the chain case 28 is fitted with a crank pulley 33. The crank pulley 33 includes a disk-shaped pulley inner part 34 coupled to the first end portion 25 of the crankshaft 10, an annular pulley outer part 35 provided on the outer periphery of the pulley inner part 34, and an elastic member 36 interposed between the pulley inner part 34 and pulley outer part 35 and joining these two parts. The elastic member 36 may be made of rubber or any similar elastomer material. The crank pulley 33 is thus provided with a dynamic damper. A belt groove 37 is formed on the outer periphery of the pulley outer part 35. A serpentine belt 38 or an auxiliary belt is passed around the crank pulley 33 to drive an alternator, an air conditioner compressor and other auxiliary devices not shown in the drawings in a per se known manner.

A second end portion 26 of the crankshaft 10 protruding from the other end of the engine 1 is fitted with a flywheel 40. The flywheel 40 includes a disk-shaped first flywheel 41 coupled to the second end portion 26, a disk-shaped second flywheel 42 provided coaxially with the first flywheel 41, and a torsional elastic device 43 interposed between the first flywheel 41 and the second flywheel 42. The elastic device 43 may consist of compression coil springs each extending in the circumferential direction, and coupled to the first flywheel 41 at one end and to the second flywheel 42 at the other end. The second flywheel 42 is connected to a transmission 45 via a clutch 44.

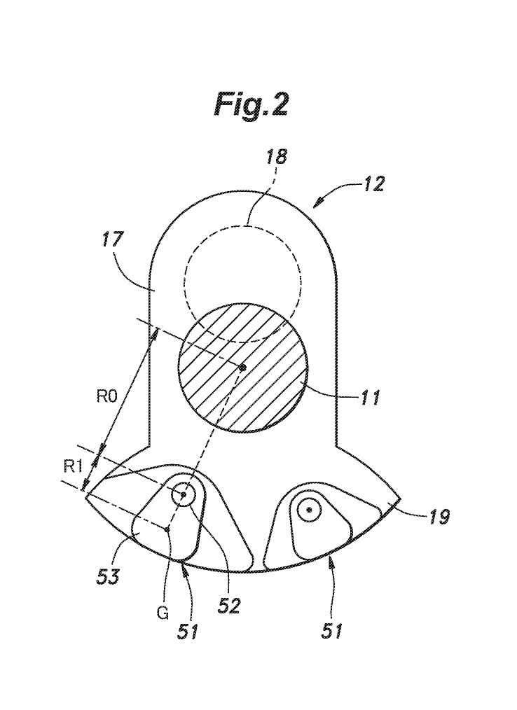

The engine 1 is provided with a vibration absorber 50 for reducing the torsional vibration of the crankshaft 10. The vibration absorber 50 is provided with at least one centrifugal pendulum damper 51 provided on at least one of the crank webs 17 of the crankshaft 10 or the pulley inner part 34. FIG. 2 shows an example in which a pair of centrifugal pendulum dampers 51 are provided on the counterweight 19 of one of the crank webs 17. As shown in FIG. 2, the centrifugal pendulum dampers 51 are each provided with a pendulum member 53 rotatably supported around a support shaft 52 by a counterweight 19. In the following description, the centrifugal pendulum dampers 51 may be collectively referred to as a single pendulum damper 51 wherever appropriate for the convenience of description. In the case of providing a centrifugal pendulum damper 51 on the pulley inner part 34, the support shaft 52 may be provided on the side surface of the pulley inner part 34 while the pendulum member 53 is rotatably supported by the support shaft 52.

The axis line of the support shaft 52 forming the rotation axis of the pendulum member 53 is provided at a position separated by a radius R0 [m] from the axis line of the crankshaft 10, and in parallel with the axis line of the crankshaft 10. The center of gravity G of the pendulum member 53 is separated from the rotation axis of the pendulum member 53 by a radius R1 [m].

The natural frequency f [Hz] of a centrifugal pendulum is expressed by the following mathematical expression (1) where the angular velocity of the crankshaft 10 is ω (rad/s).

f=ω(R0/R1)^{1/2} (1)

As can be appreciated from the equation (1), the natural frequency f of the centrifugal pendulum is proportional to the angular velocity ω of the crankshaft 10.

Since the internal combustion engine 1 according to the present embodiment consists of a four-cylinder, four-stroke engine, combustion in each cylinder 6 occurs once for two revolutions of the crankshaft 10. In other words, combustion occurs twice during each revolution of the crankshaft 10, and each combustion causes the corresponding excitation force to be applied to the crankshaft 10 so that torsional vibrations of even orders (second-order vibration, fourth-order vibration, sixth-order vibration, eighth-order vibration, and tenth-order vibration) are caused in the crankshaft 10 owing to the excitation force created by combustion.

In order to reduce the n-th-order torsional vibration of the crankshaft 10, it is preferable to define the radius R0 and the radius R1 as given the following mathematical expression (2).

n=(R0/R1)^{1/2} (2)

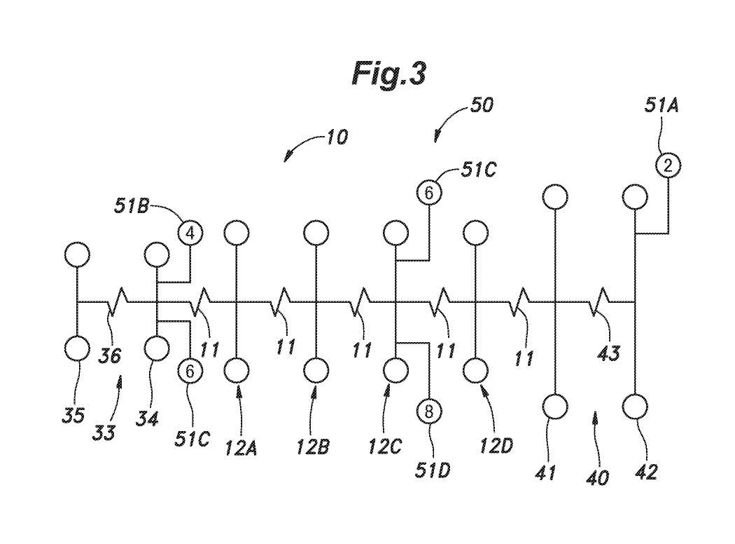

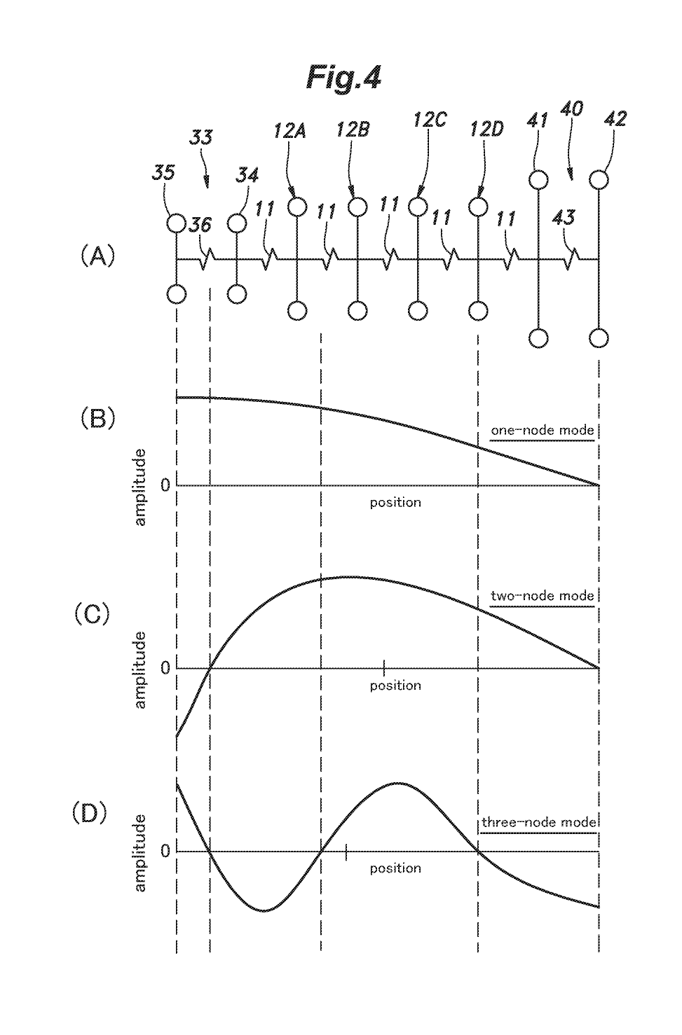

In the case a four-cylinder, four-stroke internal combustion engine 1 as is the case with this embodiment, n is selected from any one of 2, 4, 6, 8, and 10 in the equation (2), and the radius R0 and the radius R1 of the centrifugal pendulum damper 51 may be adjusted in a corresponding manner. A centrifugal pendulum damper 51 whose radius R0 and radius R1 are adjusted so as to reduce the n-th-order vibration (the second-order vibration, the fourth-order, the sixth-order, the eighth-order, or the tenth-order vibration . . . ) is called an n-th-order damper such as second-order damper 51A, fourth-order damper 51B, sixth-order damper 51C, eighth-order damper 51D, and tenth-order damper 51E, . . . (see FIGS. 3 and 4).

The dynamic model shown in (A) of FIG. 4 is not provided with a centrifugal pendulum damper 51, and different modes of torsional vibrations give rise to corresponding natural frequencies.

In a one-node mode torsional vibration shown in (B) of FIG. 4, the second end portion 26 of the crankshaft 10 connected to the flywheel 40 becomes a sole node and the first end portion 25 or a part adjacent to the inner part 34 of the pulley 33 becomes a sole anti-node.

In a two-node mode torsional vibration shown in (C) of FIG. 4, the second end portion 26 of the crankshaft 10 connected to the flywheel 40 and the first end portion 25 adjacent to the inner part 34 of the pulley 33 become nodes, respectively, and the outer part 35 of the pulley 33 and a part adjacent to the third crank throw 12C become anti-nodes, respectively.

In a three-node mode torsional vibration shown in (D) of FIG. 4, the first end portion 25 adjacent to the inner part 34 of the pulley 33 and parts adjacent to the fourth crank throw 12D and the first crank throw 12A become nodes, respectively, and the outer part 35 of the pulley 33 and parts adjacent to the second crank throw 12B and the third crank throw 12C become anti-nodes, respectively.

The inner part 34 of the pulley 33 and the parts adjacent to the second crank throw 12B and the third crank throw 12C are always anti-nodes in the one-node, two-node and three-node modes. The parts located ⅓ to ½ of the length of the crankshaft 10 as measured from the second end portion 26 of the crankshaft 10 are always anti-nodes in the one-node, two-node and three-node modes. The parts located ⅓ to ½ of the length of the crankshaft 10 as measured from the second end portion 26 of the crankshaft 10 correspond to the second cylinder 6B and the third cylinder 6C in the case of a four-cylinder engine.

As shown in FIG. 3, the centrifugal pendulum damper 51 of the present embodiment is provided in at lease one of the positions corresponding to the anti-node of the one-node mode, the anti-nodes of the two-node mode, and the anti-nodes of the three-node mode. In the present embodiment, the centrifugal pendulum damper 51 is provided in at least one of the counterweight 19 of the second crank throw 12B, the counterweight 19 of the third crank throw 12C, and the pulley inner part 34 connected to the first end portion 25.

Two or more centrifugal pendulum dampers 51 may be provided at the same position in the longitudinal direction of the crankshaft 10. The centrifugal pendulum dampers 51 provided at the same position may be tuned to reduce torsional vibrations of different orders.

As shown in FIG. 3, in the illustrated embodiment of the present embodiment, a fourth-order damper 51B and a sixth-order damper 51C are provided on the pulley inner part 34, and a sixth-order damper 51C and an eighth-order damper 51D are provided on the crank web 17 of the third crank throw 12C.

Further, a second-order damper 51A is provided on the second flywheel 42. The second-order damper 51A provided on the second flywheel 42 has the purpose of reducing the rotational speed fluctuation of the second flywheel 42.

The mode of operation and advantages of the vibration absorber 50 configured as described above are described in the following. Because the single fourth damper 51B, the two sixth-order dampers 51C and the single eighth-order damper 51D are provided on the crankshaft 10, the fourth-order, the sixth-order, and the eighth-order torsional vibrations of the crankshaft 10 are reduced. Since the natural frequency of each centrifugal pendulum damper 51 and the frequencies of the various torsional vibrations of the crankshaft 10 are all proportional to the rotational speed of the crankshaft 10, the centrifugal pendulum dampers 51 can reduce the torsional vibrations of the various orders of the crankshaft 10 without regard to the rotational speed of the crankshaft 10.

The centrifugal pendulum dampers 51 are provided in the crank web 17 of the third crank throw 12C and the pulley inner part 34 corresponding to the anti-nodes of the one-node mode, the two-node mode and the three-node torsional vibrations. Therefore, the resonant vibrations of the crankshaft 10 in the one-node mode, the two-node mode and the three-node torsional vibrations can be reduced. The pulley inner part 34 corresponds to the anti-node of the one-node mode, the two-node mode, and the three-node mode torsional vibrations of the crankshaft 10. Therefore, the centrifugal pendulum dampers 51 provided on the crank web 17 of the third crank throw 12C and the pulley inner part 34 can reduce the resonant vibrations of the crankshaft 10 corresponding to the one-node mode, the two-node mode, and the three-node mode torsional vibrations. As a result, the resonant vibrations of the torsional vibration of the crankshaft 10 are effectively suppressed.

Simulations were performed for the purpose of confirming the relationship between the positions where the centrifugal pendulum dampers 51 are provided and the vibration reduction effect, and the following results were obtained. The simulations were conducted on Example 1 for Comparison having no centrifugal pendulum damper, Example 2 for Comparison having a centrifugal pendulum damper only in the pulley inner part 34, and the present embodiment having centrifugal pendulum dampers 51 in the pulley inner part 34 and the crank web 17 of the third crank throw 12C.

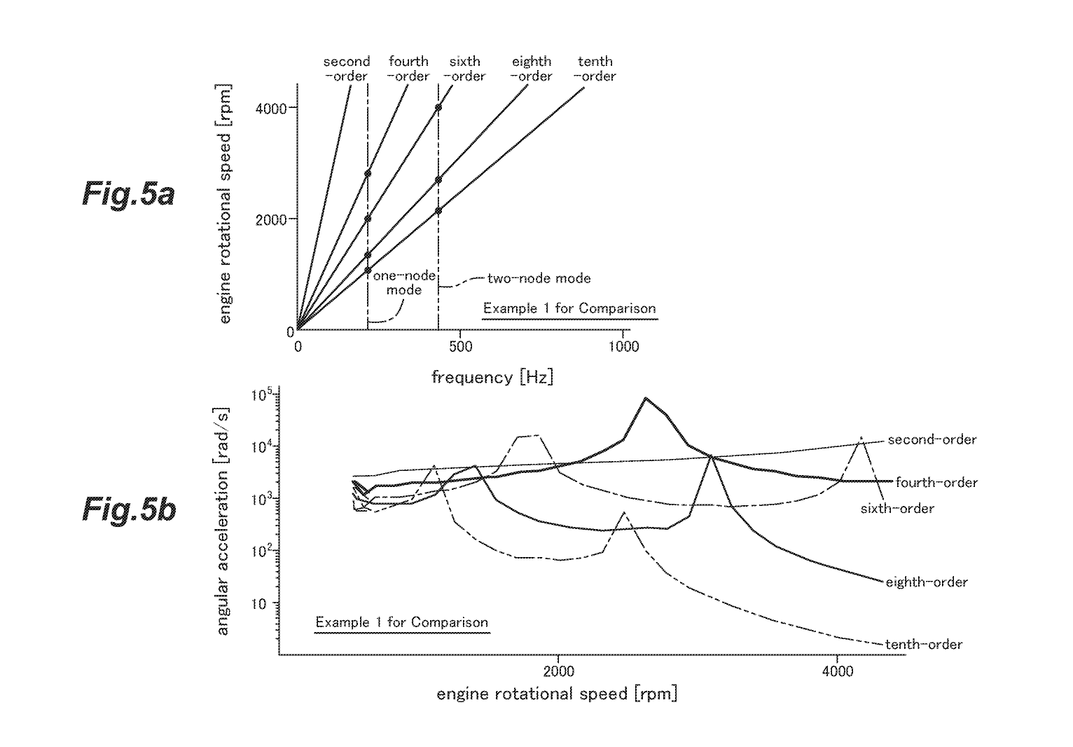

FIG. 5a is a graph showing the torsional resonant vibrations of different orders that occur in relation to the rotational speeds of the engine in First Example for Comparison, and FIG. 5b is a graph showing the angular accelerations of the crankshaft in various torsional vibration modes in relation to the rotational speed of the engine in First Example for Comparison.

As shown in FIG. 5a, in the normal rotational range (1,000 rpm to 4,000 rpm) of the internal combustion engine 1, the fourth-order, sixth-order, eighth-order, and tenth-order torsional vibrations may include one-node mode and two-mode torsional vibrations. When the vibration frequencies of any such torsional vibrations coincide with resonant torsional vibrations of the crankshaft 10, the amplitude of the torsional vibration increases as indicated by the peaks in FIG. 5b. In the normal rotational speed range, the fourth-order vibration resonates at the natural frequency of the one-node mode vibration, and a corresponding peak occurs. The sixth-order, eighth-order, and tenth-order vibrations resonate at the natural frequencies of the one-node mode and the two-node mode vibrations, and two peaks occur in each case. The tenth-order vibration is very small in amplitude as compared to the vibrations of other orders, and has little influence on the overall vibration of the crankshaft 10. Resonance caused by the one-node mode vibration occurs in the low rotational speed range (1,000 to 2,000 Hz) of the engine 1, and resonance caused by the two-node mode vibration occurs in the intermediate rotational speed range (2,000 to 4,000 Hz) of the engine 1.

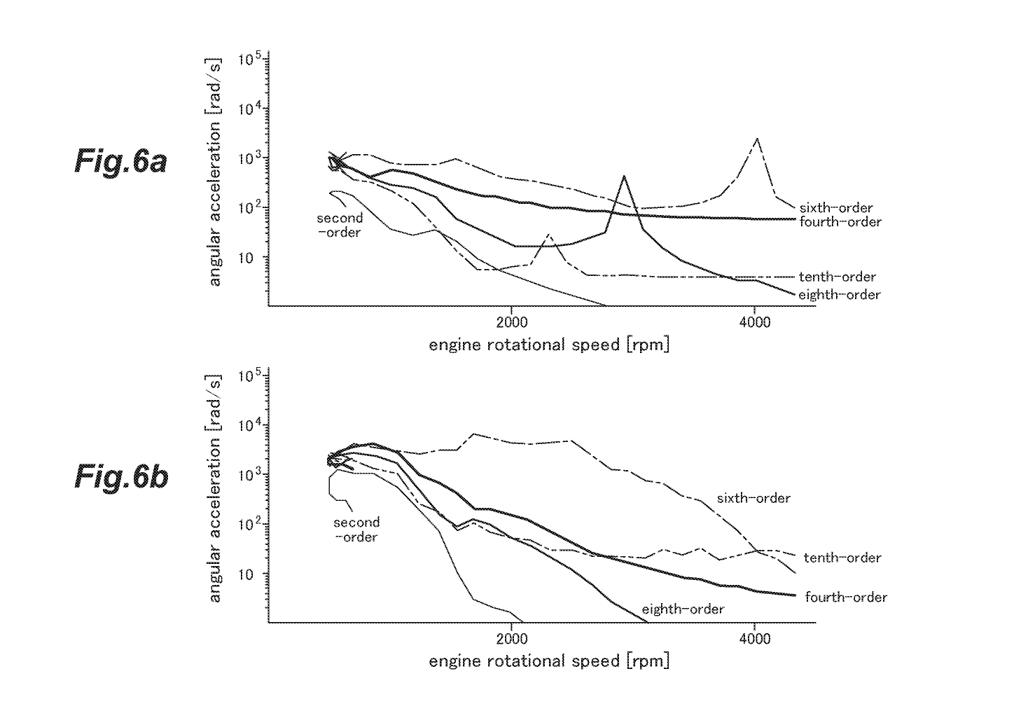

FIG. 6a is a graph showing the angular acceleration of the crankshaft in various torsional vibration modes in relation to the rotational speed of the engine in Second Example for Comparison. In Second Example for Comparison, a fourth-order damper 51B, a sixth-order damper 51C, an eighth-order damper 51D, and a tenth-order damper 51E are provided on the pulley inner part 34. The fourth-order damper 51B, the sixth-order damper 51C, the eighth-order damper 51D, and the tenth-order damper 51E suppress the fourth-order, sixth-order, eighth-order, and tenth-order torsional vibrations of the crankshaft 10. Further, because these dampers are provided on the pulley inner part 34, the natural frequency vibrations of the first end portion 25 of the crankshaft 10 (or the pulley inner part 34) in the one-node mode, the two-node mode, and the three-node mode are suppressed, and resonance in any of these frequencies can be minimized. As a result, the peaks of the fourth-order, sixth-order, eighth-order vibration, and tenth-order vibrations that can otherwise appear in a 1,000 to 2,000 Hz frequency range disappear.

FIG. 6b is a graph showing the angular acceleration of the crankshaft in various torsional vibration modes in relation to the rotational speeds of the engine in the present embodiment. In the present embodiment, a fourth-order damper 51B, a sixth-order damper 51C, an eighth-order damper 51D, and a tenth-order damper 51E are provided on each of the pulley inner part 34 and the crank web 17 of the third crank throw 12C. The fourth-order damper 51B, the sixth-order damper 51C, the eighth-order damper 51D, and the tenth-order damper 51E suppress the fourth-order, sixth-order, eighth-order, and tenth-order torsional vibrations of the crankshaft 10. Further, owing to the dampers provided on the pulley inner part 34, the natural frequency vibrations of the first end portion 25 of the crankshaft 10 (or the pulley inner part 34) in the one-node mode and the two-node mode are suppressed, and resonance in any of these frequencies can be minimized. Also, owing to the dampers provided on the crank web 17 of the third crank throw 12C, the natural frequency vibrations of the part of the crankshaft 10 corresponding to the third cylinder 6C in the one-node mode, the two-node mode and the three-node mode are suppressed, and resonance in any of these frequencies can be minimized. These dampers thus suppress the one-node mode, the two-node mode and the three-node mode vibrations at the two anti-nodes, and the peaks of the fourth-order, sixth-order, eighth-order vibration, and tenth-order vibrations that can otherwise appear in a 2,000 to 4,000 Hz frequency range disappear.

Since the centrifugal pendulum dampers 51 according to the present embodiment are tuned so as to reduce higher order vibrations than the second-order, it is possible to efficiently reduce the vibration of the internal combustion engine 1 in the normal rotational range. In addition, since a plurality of centrifugal pendulum dampers 51 are provided at the same position (in two positions in the illustrated embodiment) in the lengthwise direction of the crankshaft 10, and are adjusted so as to reduce vibrations of different orders, higher order vibrations such as the fourth-order, sixth-order and eighth-order torsional vibrations can also be suppressed.

In the case where the centrifugal pendulum damper 51 is provided at the first end portion 25 of the crankshaft 10 by providing the centrifugal pendulum damper 51 at the pulley inner part 34, the centrifugal pendulum damper 51 can be placed at some distance from the rotation axis of the crankshaft 10 in the radial direction. As a result, the radius R0 of the centrifugal pendulum damper 51 can be selected relatively freely so that the centrifugal pendulum damper 51 can be arranged in an efficient manner.

The centrifugal pendulum damper 51 according to the present embodiment can also reduce bending vibrations of the crankshaft 10. In the case where the centrifugal pendulum damper 51 is provided in the second crank throw 12B or the third crank throw 12C or any intermediate position of the crankshaft 10 with respect to the lengthwise direction thereof, bending vibrations can be reduced in a particularly efficient manner.

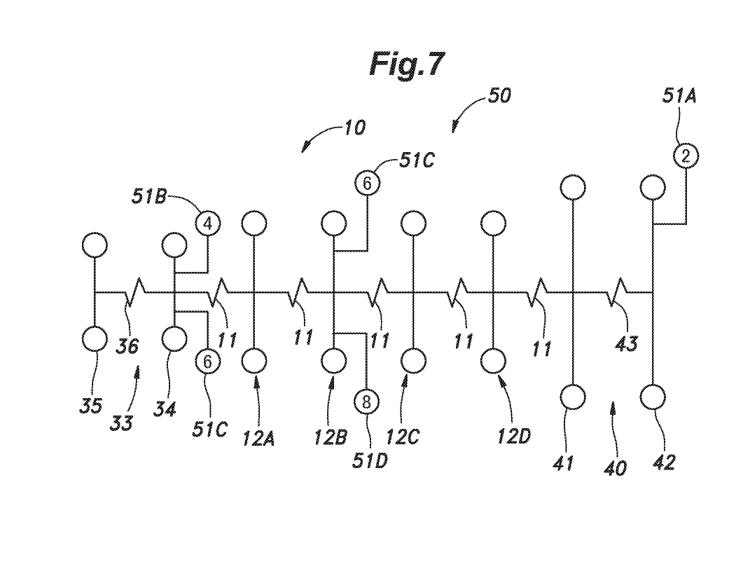

The illustrated embodiment can be modified in a number of different ways without departing from the spirit of the present invention. In a modified embodiment shown in FIG. 7, a fourth-order damper 51B and a sixth-order damper 51C are provided on the pulley inner part 34, and a sixth-order damper 51C and an eighth-order damper 51D are provided on the crank web 17 of the second crank throw 12B. In this way, the centrifugal pendulum damper 51 may be provided on the second crank throw 12B instead of the third crank throw 12C.

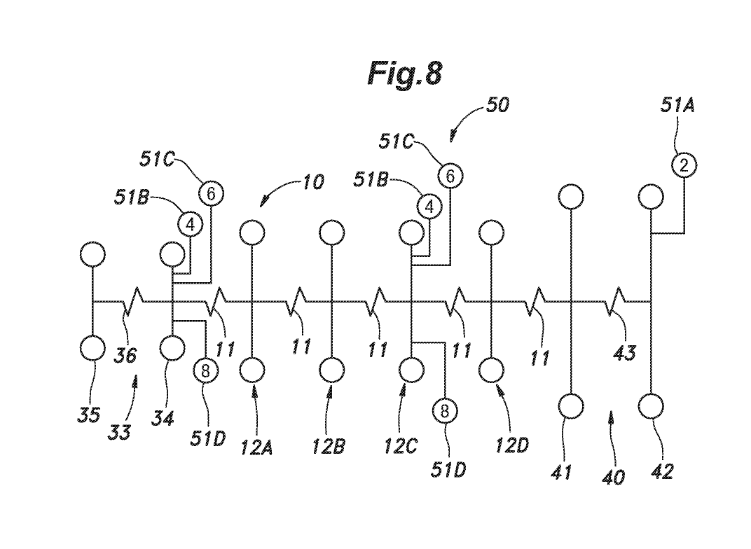

In another modified embodiment shown in FIG. 8, a fourth-order damper 51B, a sixth-order damper 51C, and an eighth-order damper 51D are provided on the pulley inner part 34, and a fourth-order damper 51B, a sixth-order damper 51C, and an eighth-order damper 51D are similarly provided on the crank web 17 of the third crank throw 12C. In this case also, the fourth-order damper 51B, the sixth-order damper 51C, and the eighth-order damper 51D may be provided on the second crank throw 12B instead of the third crank throw 12C.

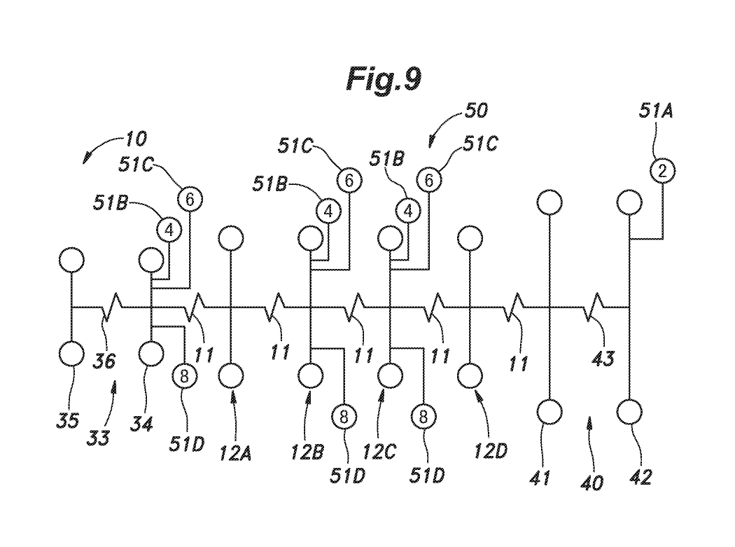

In yet another modified embodiment shown in FIG. 9, a fourth-order damper 51B, a sixth-order damper 51C, and an eighth-order damper 51D are provided on the pulley inner part 34, a fourth-order damper 51B, a sixth-order damper 51C, and an eighth-order damper 51D are provided on the crank web 17 of the second crank throw 12B, and a fourth-order damper 51B, a sixth-order damper 51C, and an eighth-order damper 51D are provided on the crank web 17 of the third crank throw 12C. In this embodiment, the fourth-order damper 51B, the sixth-order damper 51C, and the eighth-order damper 51D may be provided in at least one of the second crank throw 12B and the third crank throw 12C. It is also possible to provide a fourth-order damper 51B and the sixth-order damper 51C on the second crank throw 12B and the eighth-order damper 51D on the third crank throw 12C.

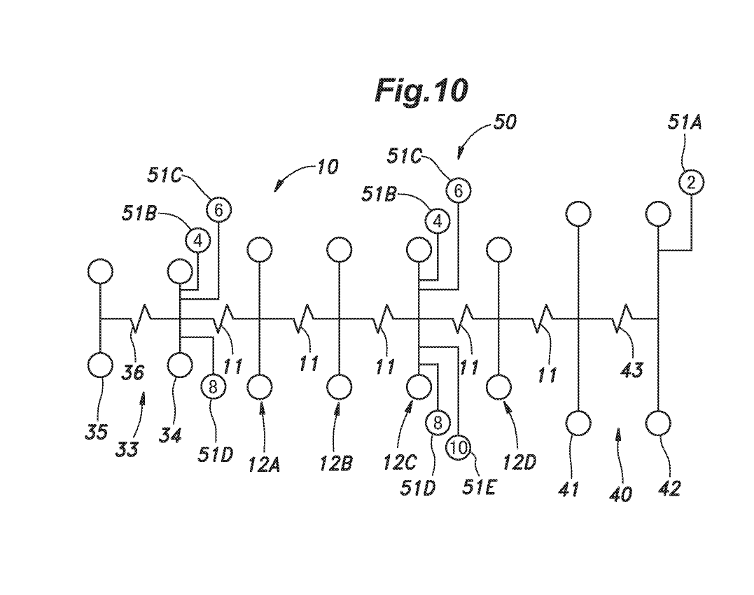

In yet another modified embodiment shown in FIG. 10, a fourth-order damper 51B, a sixth-order damper 51C, and an eighth-order damper 51D are provided on the pulley inner part 34, and a fourth-order damper 51B, a sixth-order damper 51C, an eighth-order damper 51D, and a tenth-order damper 51E are provided on the crank web 17 of the third crank throw 12C. In this case, the fourth-order damper 51B, the sixth-order damper 51C, the eighth-order damper 51D, and the tenth-order damper 51E may also be provided on the crank web 17 of the second crank throw 12B.

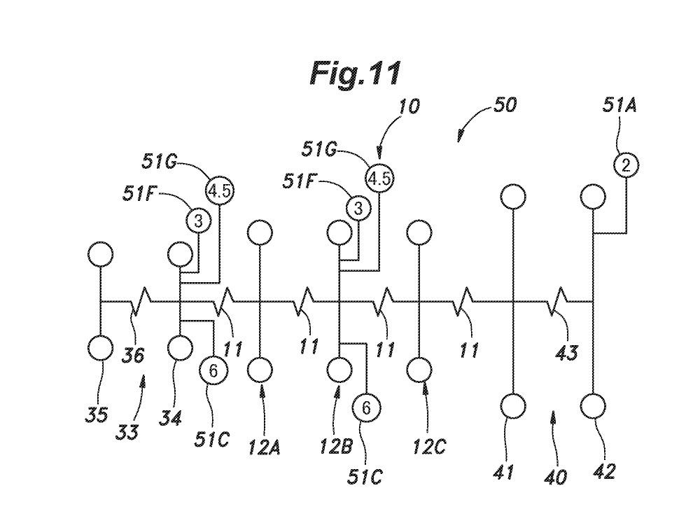

FIG. 11 shows a case where the present invention is applied to a three-cylinder, four-stroke engine. Similarly as in the case of a four-cylinder engine, a centrifugal pendulum damper 51 may be disposed in at least one of the anti-nodes of torsional vibrations of the crankshaft 10 in a one-node mode, a two-node mode and a three-node mode torsional vibration. Preferably, a centrifugal pendulum damper 51 is disposed at a position which coincides with an anti-node in all of one-node mode, two-node mode and three-node mode torsional vibrations. A three-cylinder engine may be considers as a four-cylinder engine minus the fourth cylinder 6D and the fourth crank throw 12D. In the case of a three-cylinder, two-stroke engine, combustion occurs 1.5 times for each revolution of the crankshaft 10, and an exciting force resulting from the combustion is applied to the crankshaft 10. Torsional vibration of a frequency which is 1.5 times the rotational speed of the crankshaft (third-order vibration, 4.5th-order vibration, sixth-order vibration, 7.5th-order vibration, and ninth-order vibration) is applied to the crankshaft 10 by the excitation force created by combustion.

As shown in FIG. 11, in the case of a three-cylinder engine, a third-order damper 51F, a 4.5th-order damper 51G, and a 6th-order damper 51C are provided on the pulley inner part 34, and a third-order damper 51F, a 4.5th-order damper 51G, and a 6th-order damper 51C are provided on the crank web 17 of the second crank throw 12B. The third-order damper 51F, the 4.5th-order damper 51G, and the 6th-order damper 51C are provided on at least one of the pulley inner part 34 and the second crank throw 12B. The pulley inner part 34 and the second crank throw 12B coincide with the anti-nodes of the one-node mode, the two-mode and the three-mode vibrations. A 7.5th-order damper may be provided on at least one of the pulley inner part 34 and the second crank throw 12B.

The present invention has been described in terms of preferred embodiments thereof, but is not limited by the illustrated embodiments, and can be modified and substituted in various ways without departing from the spirit of the present invention.

For instance, the centrifugal pendulum damper described in the foregoing embodiments are given only as an example, and can be any other type of per se known centrifugal pendulum damper.

1. A vibration absorber for an internal combustion engine having a plurality of cylinders arranged in a row, comprising:
a crankshaft corresponding to the cylinders;
a crank pulley provided in a first end portion of the crankshaft;
a flywheel provided in a second end portion of the crankshaft; and
at least one centrifugal pendulum damper provided in at least one of positions of the crankshaft corresponding to anti-nodes of one-node mode, two-node mode and three-node mode torsional vibrations of the crankshaft.

2. The vibration absorber as defined in claim 1, wherein the at least one centrifugal pendulum damper includes a centrifugal pendulum damper positioned so as to correspond to a cylinder adjacent to a position located ⅓ to ½ of a length of the crankshaft as measured from the second end portion of the crankshaft.

3. The vibration absorber as defined in claim 1, wherein the at least one centrifugal pendulum damper includes a centrifugal pendulum damper located in the first end portion of the crankshaft.

4. The vibration absorber as defined in claim 2, wherein the at least one centrifugal pendulum damper includes another centrifugal pendulum damper provided in the first end portion of the crankshaft.

5. The vibration absorber as defined in claim 1, wherein the at least one centrifugal pendulum damper is tuned to a higher order torsional vibration of the crankshaft than a second-order torsional vibration.

6. The vibration absorber as defined in claim 5, wherein the at least one centrifugal pendulum damper is tuned to at least one of fourth-order, sixth-order and eighth-order torsional vibrations of the crankshaft.

7. The vibration absorber as defined in claim 6, wherein the at least one centrifugal pendulum damper includes two or more centrifugal pendulum dampers located at a same lengthwise position of the crankshaft.

8. The vibration absorber as defined in claim 7, wherein the two or more centrifugal pendulum dampers located at a same lengthwise position of the crankshaft are tuned to torsional vibrations of different orders.

9. The vibration absorber as defined in claim 1, wherein the crank pulley includes a pulley inner part fixedly connected to the crankshaft, and a pulley outer part connected to an outer periphery of the inner part via an elastic member and configured to have a belt passed around an outer periphery thereof, the at least one centrifugal pendulum damper comprising a centrifugal pendulum damper attached to the pulley inner part.

10. The vibration absorber as defined in claim 9, wherein the cylinders consist of a first cylinder, a second cylinder, a third cylinder, and a fourth cylinder arranged in that order from the first end portion of the crankshaft, and the at least one centrifugal pendulum damper comprises a fourth-order damper attached to the pulley inner part, and a sixth-order damper attached to a part of the crankshaft corresponding to the second cylinder or the third cylinder.

11. The vibration absorber as defined in claim 10, wherein the at least one centrifugal pendulum damper further comprises an additional sixth-order damper attached to the pulley inner part.

12. The vibration absorber as defined in claim 11, wherein the at least one centrifugal pendulum damper further comprises an eighth-order damper attached to a part of the crankshaft corresponding to the second cylinder or the third cylinder.

13. The vibration absorber as defined in claim 9, wherein the cylinders consist of a first cylinder, a second cylinder, a third cylinder, and a fourth cylinder arranged in that order from the first end portion of the crankshaft, and the at least one centrifugal pendulum damper comprises a fourth-order damper, a sixth-order damper and an eighth-order damper attached to the pulley inner part, and another fourth-order damper, another sixth-order damper and another eighth-order damper attached to a part of the crankshaft corresponding to the second cylinder or the third cylinder.
